(19) United States
(12) Patent Application Publication
(10) Pub. No.: US 2011/0231090 A1
(43) Pub. Date: Sep. 22, 2011

(54) MAP INFORMATION PROCESSING DEVICE

(76) Inventors: Tomoya Ikeuchi, Tokyo (JP); Makoto Mikuriya, Tokyo (JP); Masaharu Umezu, Tokyo (JP); Yasushi Kodaka, Tokyo (JP); Kosei Uchino, Tokyo (JP)

(21) Appl. No.: 13/131,726

(22) PCT Filed: Nov. 25, 2009
(86) PCT No.: PCT/JP2009/006348

§ 371 Date: May 27, 2011

(30) Foreign Application Priority Data
Feb. 18, 2009 (JP) 2009-035436

(51) Int. Cl. G01C 21/36

(52) U.S. Cl. 701/201; 701/208

(57) ABSTRACT

A map information processing device includes a map information storage unit 23 for storing map information, a sensor information input unit 22 for inputting sensor information used for calculation of a current position, a navigation processing unit 25 for, when determining that a vehicle has entered a tunnel on a basis of a current position which the navigation processing unit calculates by using the map information read from the map information storage unit and the sensor information inputted from the sensor information input unit, creating a map image having a display scale with which a whole shape of the above-mentioned tunnel is included in a single screen, and an output control unit 26 for outputting the map image created by the navigation processing unit.

### FIELD OF THE INVENTION

The present invention relates to a map information processing device which is applied to a navigation device, for example, and which processes map information. More particularly, it relates to a technology of ideally displaying map information while a vehicle is traveling through a tunnel.

### BACKGROUND OF THE INVENTION

A conventional navigation device displays a tunnel in a form different from that in which roads are displayed on a map while a vehicle equipped with the navigation device is traveling through the tunnel. However, because the remaining distance of the tunnel is not displayed on the map, the driver may have an uncertain, insecure feeling resulting from being unable to acquire information about the distance to the tunnel exit while the vehicle is traveling through a long tunnel.

As a technology of outputting information about a tunnel, patent reference 1 discloses a navigation device that can notify the driver about a relationship between the current position and an evacuation route promptly when the driver encounters an accident or the like in a tunnel. When the driver encounters an accident or the like in a tunnel, this conventional navigation device detects the emergency situation, such as an accident, according to the user's command or automatically, and informs the relationship between the current position and an emergency exit to the user.

### RELATED ART DOCUMENT

### Patent Reference

Patent reference 1: JP,2008-96346,A

### SUMMARY OF THE INVENTION

However, because the navigation device disclosed by above-mentioned patent reference 1 does not present any information about tunnel exits to the driver during normal travel of the vehicle through any tunnel, the navigation device cannot remove an uncertain, insecure feeling, as mentioned above, which the driver may have.

The present invention is made in order to solve the above-mentioned problem, and it is therefore an object of the present invention to provide a map information processing device that can remove an uncertain, insecure feeling which the driver may have when driving through a tunnel.

In order to solve the above-mentioned problem, in accordance with the present invention, there is provided a map information processing device including: a map information storage unit for storing map information; a sensor information input unit for inputting sensor information used for calculation of a current position; a navigation processing unit for, when determining that a vehicle has entered a tunnel on a basis of a current position which the navigation processing unit calculates by using the map information read from the map information storage unit and the sensor information inputted from the sensor information input unit, creating a map image having a display scale with which a whole shape of the above-mentioned tunnel is included in a single screen; and an output control unit for outputting the map image created by the navigation processing unit.

Because when the vehicle has entered a tunnel, the map information processing device in accordance with the present invention displays a map image including the whole shape of the tunnel in such a way that the map image is included in a single screen, the psychological burden on the driver resulting from being unable to acquire any information about tunnel exits can be reduced.

### BRIEF DESCRIPTION OF THE FIGURES

FIG. 1 is a block diagram showing the structure of a map information processing device in accordance with Embodiment 1 of the present invention;

FIG. 2 is a flow chart showing main processing performed in tunnel displaying processing carried out by the map information processing device in accordance with Embodiment 1 of the present invention;

FIG. 3 is a flow chart showing tunnel shape determination processing (a first half) performed in the tunnel display processing carried out by the map information processing device in accordance with Embodiment 1 of the present invention;

FIG. 4 is a flow chart showing tunnel shape determination processing (a second half) performed in the tunnel display processing carried out by the map information processing device in accordance with Embodiment 1 of the present invention;

FIG. 5 is a flow chart showing map image scale determination processing performed in the tunnel display processing carried out by the map information processing device in accordance with Embodiment 1 of the present invention;

FIG. 6 is a view showing an example of a display scale table for use in the map information processing device in accordance with Embodiment 1 of the present invention; and

FIG. 7 is a flow chart showing main processing performed in tunnel displaying processing carried out by a map information processing device in accordance with Embodiment 2 of the present invention.

### EMBODIMENTS OF THE INVENTION

Hereafter, in order to explain this invention in greater detail, the preferred embodiments of the present invention will be described with reference to the accompanying drawings.

### Embodiment 1

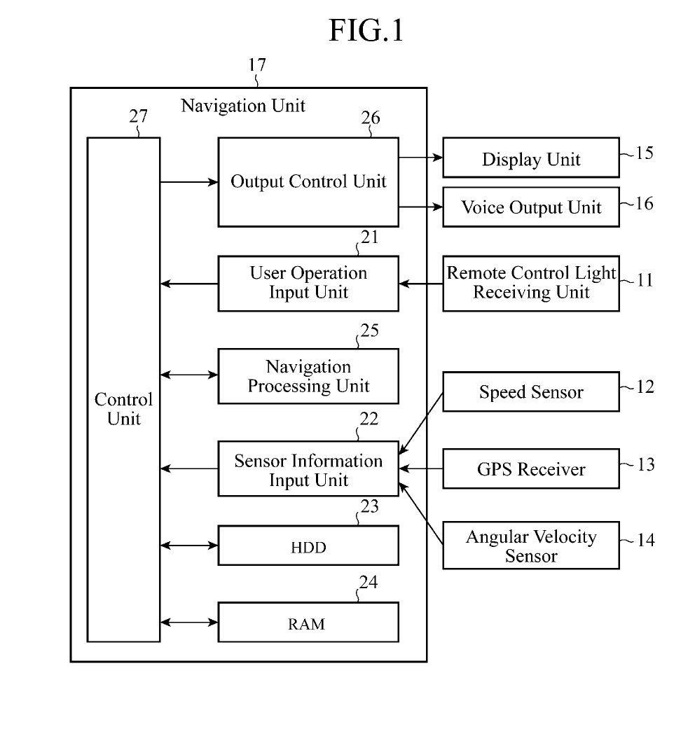

FIG. 1 is a block diagram showing the structure of a map information processing device in accordance with Embodiment 1 of the present invention. Hereafter, an example in which the map information processing device is applied to a navigation device will be explained. This map information processing device is provided with a remote controller (abbreviated to as a “remote control” from here on) light receiving unit 11, a speed sensor 12, a GPS (Global Positioning System) receiver 13, an angular velocity sensor 14, a display unit 15, a voice output unit 16, and a navigation unit 17.

The remote control light receiving unit 11 receives a signal (an infrared ray or a radio wave) for commanding the navigation device to perform an operation, which is sent from a wireless remote control (not shown) operated by a user, and sends the signal received thereby to the navigation unit 17 as an operation signal.

The speed sensor 12 measures the speed of itself moving, and informs the speed to the navigation unit 17 as a speed signal. The GPS receiver 13 receives radio waves transmitted from GPS satellites, and sends the radio waves to the navigation unit 17 as GPS signals. The angular velocity sensor 14 measures a direction change of itself, and informs the direction change to the navigation unit 17 as a heading signal.

The display unit 15 is comprised of a liquid crystal display, for example, and displays a map image or information, such as an optimal route, according to an image signal sent thereto from the navigation unit 17. The voice output unit 16 is comprised of a speaker, for example. According to a voice signal sent thereto from the navigation unit 17, the voice output unit 16 outputs a voice providing guidance to a destination according to the optimal route, and also outputs a voice providing various pieces of information included in map information.

The navigation unit 17 is provided with a user operation input unit 21, a sensor information input unit 22, an HDD (Hard Disk Drive) 23, a RAM (Random Access Memory) 24, a navigation processing unit 25, an output control unit 26, and a control unit 27.

The user operation input unit 21 receives the operation signal sent thereto from the remote control light receiving unit 11, and sends the operation signal to the control unit 27. The sensor information input unit 22 receives the vehicle speed signal sent thereto from the speed sensor 12, the GPS signals sent thereto from the GPS receiver 13, and the heading signal sent thereto from the angular velocity sensor 14, and sends those signals to the control unit 27 as sensor information.

The HDD 23 corresponds to a map information storage unit in accordance with the present invention, and stores map information. The map information is represented by a graph structure in which each intersection is defined as a node and each road between intersections is defined as a link. A tunnel flag showing whether or not the road is a tunnel is added to each link. If the road is a tunnel, the tunnel flag is set to “1”; otherwise, the tunnel flag is set to “0”. Furthermore, information showing directions in which a vehicle equipped with this map information processing device can travel is added to each link. In addition, shape point coordinates for representing the shape of each link are added to the link. Each link has one or more shape point coordinates, and no shape point coordinates are added when unnecessary. The map information stored in this HDD 23 can be read by the control unit 27.

Furthermore, a display scale table (refer to FIG. 6), in addition to the map information, is stored in the HDD 23, as will be mentioned below in detail. The map information storage unit in accordance with the present invention is not limited to the HDD. For example, a disk drive device that reads map information stored in a recording medium, such as a DVD (Digital Versatile Disk) or a CD (Compact Disc), can be used as the map information storage unit.

The RAM 24 temporarily stores data used for various processes. For example, the map information read from the HDD 23 is written into the RAM 24 via the control unit 27. Furthermore, the map information stored in the RAM 24 can be read by the navigation processing unit 25 via the control unit 27.

The navigation processing unit 25 performs one of various processes to implement a navigation function according to a command from the control unit 27. For example, the navigation processing unit 25 performs a process for implementing a current position calculating function of detecting a current point by using the sensor information sent thereto from the sensor information input unit 22 via the control unit 27, and calculating a position on the road where this detected current point exists (simply referred to as a “current position” from here on) with reference to the map information read from the HDD 23 via the control unit 27, a map display function of creating a map image about a map of an area in the vicinity of the current position or an area including an arbitrary point, which is to be displayed on the display unit 15, a route determining function of determining an optimal route from the current position to an arbitrary point or between two arbitrary points, a route guiding function of providing guidance about a destination, a right or left turn or the like according to the optimal route determined by the route determining function, or the like. Each of these functions is implemented with reference to the map information stored in the HDD 23. The process results obtained by this navigation processing unit 25 are sent to the control unit 27.

The output control unit 26 generates an image signal according to the results of the navigation process sent thereto via the control unit 27 from the navigation processing unit 25 and sends the image signal to the display unit 15, and also generates a voice signal according to the results of the navigation process and sends this voice signal to the voice output unit 16.

The control unit 27 controls the whole of the navigation unit 17 by controlling transmission and reception of data among the user operation input unit 21, the sensor information input unit 22, the HDD 23, the RAM 24, the navigation processing unit 25, and the output control unit 26.

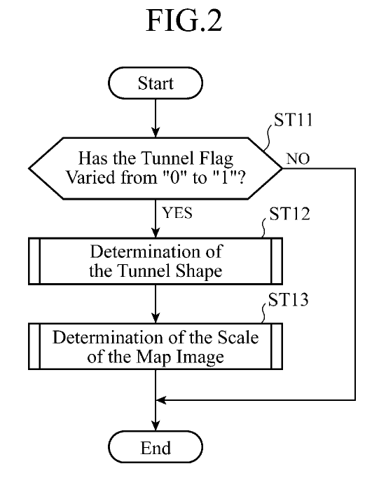

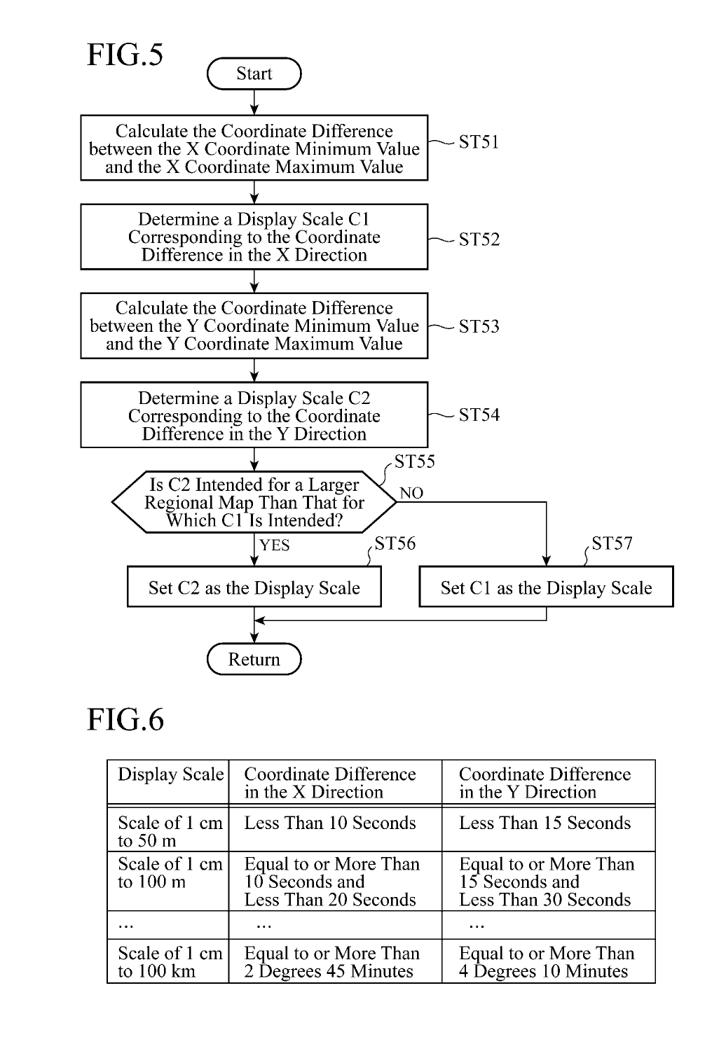

Next, the operation of the map information processing device in accordance with Embodiment 1 constructed as mentioned above will be explained with reference to flow charts shown in FIGS. 2 and 5, focusing on tunnel display processing of displaying a tunnel.

First, main processing performed in the tunnel display processing will be explained with reference to the flow chart shown in FIG. 2. In the main process display processing, whether the tunnel flag has varied from “0” to “1” is checked to see first (step ST11). More specifically, the navigation processing unit 25 calculates the current position by using the current position calculation function to check to see whether or not the tunnel flag added to the link where this calculated current position exists is “1” and the tunnel flag added to the previous link along which the vehicle was traveling immediately before entering the current link is “0”, that is, whether the tunnel flag has varied from “0” to “1”. When, in this step ST11, determining that the tunnel flag has not varied from “0” to “1”, the navigation processing unit recognizes that the vehicle has not entered any tunnel and ends the main processing.

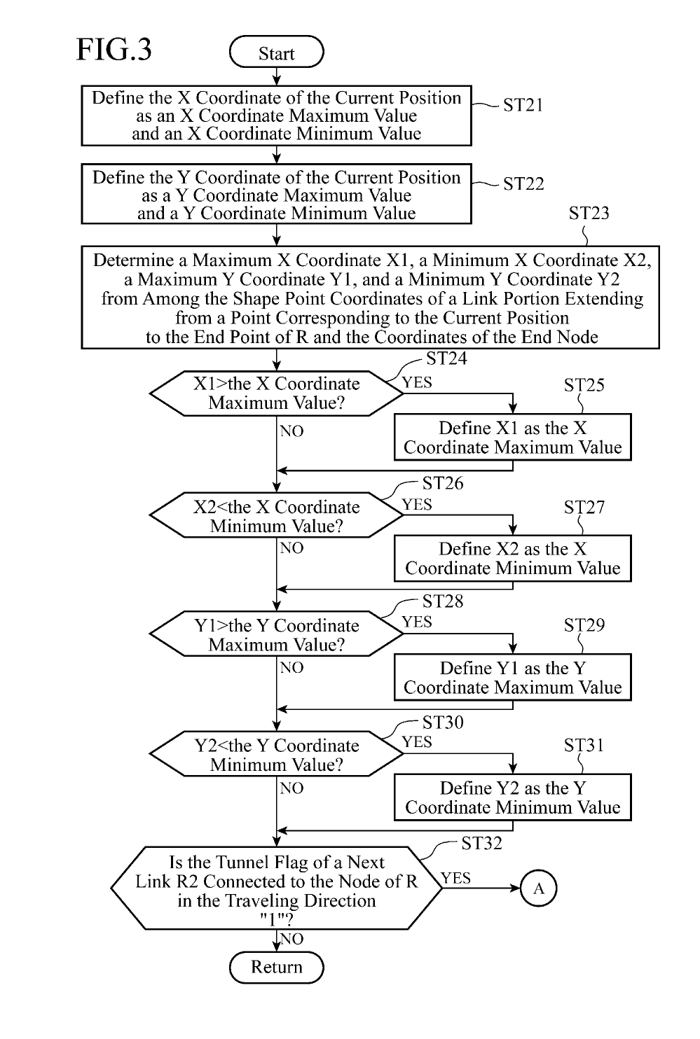

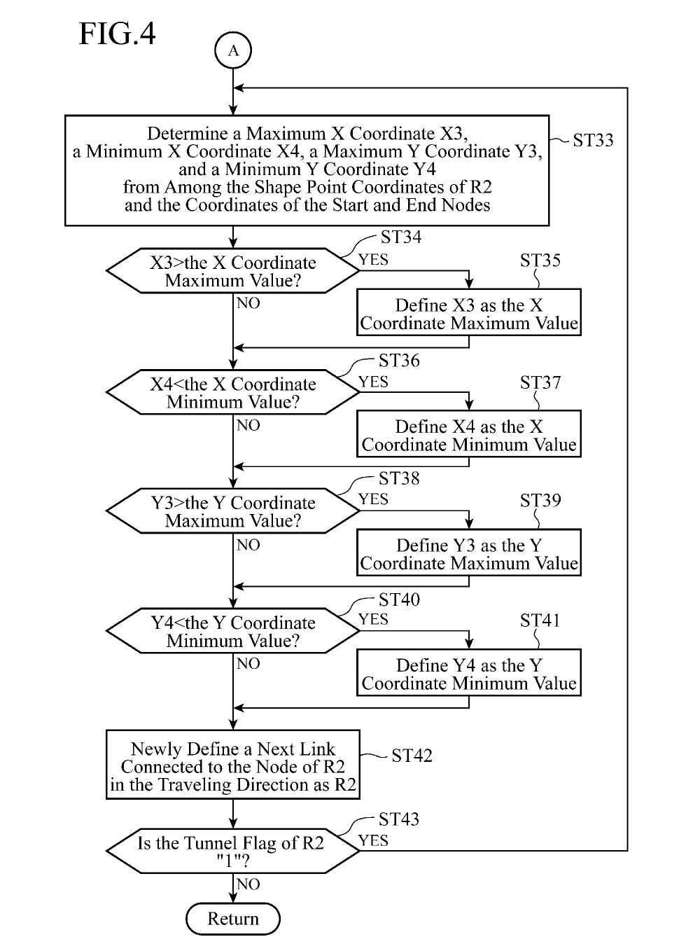

In contrast, when it is determined, in step ST11, that the tunnel flag has varied from “0” to “1”, it is recognized that the vehicle has entered a tunnel and tunnel shape determination processing is then performed (step ST12). The details of this tunnel shape determination processing will be explained with reference to the flow charts shown in FIGS. 3 and 4. This tunnel shape determination processing is mainly performed by the navigation processing unit 25.

In the tunnel shape determination processing, the X coordinate of the current position is defined as an “X coordinate maximum value” and an “X coordinate minimum value” first (step ST21). The Y coordinate of the current position is then defined as a “Y coordinate maximum value” and a “Y coordinate maximum value” (step ST22). Then, from among the shape point coordinates of a link portion extending from a point corresponding to the current position to the end node of a link (a reference link R) corresponding to the road where the vehicle is positioned and the coordinates of the end node, a maximum X coordinate X1, a minimum X coordinate X2, a maximum Y coordinate Y1, and a minimum Y coordinate Y2 are determined (step ST23).

Whether or not the maximum X coordinate X1 is larger than the X coordinate maximum value is then checked to see (step ST24). When, in this step ST24, determining that the maximum X coordinate X1 is not larger than the X coordinate maximum value, the navigation processing unit advances the sequence to step ST26. In contrast, when, in step ST24, determining that the maximum X coordinate X1 is larger than the X coordinate maximum value, the navigation processing unit redefines the maximum X coordinate X1 as the X coordinate maximum value (step ST25). After that, the navigation processing unit advances the sequence to step ST26.

In step ST26, whether or not the minimum X coordinate X2 is smaller than the X coordinate minimum value is checked to see. When, in this step ST26, determining that the minimum X coordinate X2 is not smaller than the X coordinate minimum value, the navigation processing unit advances the sequence to step ST28. In contrast, when, in step ST26, determining that the minimum X coordinate X2 is smaller than the X coordinate minimum value, the navigation processing unit redefines the minimum X coordinate X2 as the X coordinate minimum value (step ST27). After that, the navigation processing unit advances the sequence to step ST28.

In step ST28, whether or not the maximum Y coordinate Y1 is larger than the Y coordinate maximum value is checked to see. When, in this step ST28, determining that the maximum Y coordinate Y1 is not larger than the Y coordinate maximum value, the navigation processing unit advances the sequence to step ST30.

In contrast, when, in step ST28, determining that the maximum Y coordinate Y1 is larger than the Y coordinate maximum value, the navigation processing unit redefines the maximum Y coordinate Y1 as the Y coordinate maximum value (step ST29). After that, the navigation processing unit advances the sequence to step ST30.

In step ST30, whether or not the minimum Y coordinate Y2 is smaller than the Y coordinate maximum value is checked to see. When, in this step ST30, determining that the minimum Y coordinate Y2 is not smaller than the Y coordinate maximum value, the navigation processing unit advances the sequence to step ST32. In contrast, when, in step ST30, determining that the minimum Y coordinate Y2 is smaller than the Y coordinate maximum value, the navigation processing unit redefines the minimum Y coordinate Y2 as the Y coordinate maximum value (step ST31). After that, the navigation processing unit advances the sequence to step ST32.

In step ST32, whether or not the tunnel flag of a link (referred to as a “link R2” from here on) connected to the end node of the reference link R in the traveling direction is “1” is checked to see. When, in this step ST32, determining that the tunnel flag of the link R2 is not “1”, the navigation processing unit recognizes that the end node of the link R2 is a tunnel end point, ends the tunnel shape determination processing, and then returns the sequence to the main processing.

When, in above-mentioned step ST32, determining that the tunnel flag of the link R2 is “1”, the navigation processing unit recognizes that the tunnel leads forward, and, from among the shape point coordinates of the link R2, the coordinates of the start node, and the coordinates of the end node, determines a maximum X coordinate X3, a minimum X coordinate X4, a maximum Y coordinate Y3, and a minimum Y coordinate Y4 (step ST33).

Whether or not the maximum X coordinate X3 is larger than the X coordinate maximum value is then checked to see (step ST34). When, in this step ST34, determining that the maximum X coordinate X3 is not larger than the X coordinate maximum value, the navigation processing unit advances the sequence to step ST36. In contrast, when, in step ST34, determining that the maximum X coordinate X3 is larger than the X coordinate maximum value, the navigation processing unit redefines the maximum X coordinate X3 as the X coordinate maximum value (step ST35). After that, the navigation processing unit advances the sequence to step ST36.

In step ST36, whether or not the minimum X coordinate X4 is smaller than the X coordinate minimum value is checked to see. When, in this step ST36, determining that the minimum X coordinate X4 is not smaller than the X coordinate minimum value, the navigation processing unit advances the sequence to step ST38. In contrast, when, in step ST36, determining that the minimum X coordinate X4 is smaller than the X coordinate minimum value, the navigation processing unit redefines the minimum X coordinate X4 as the X coordinate minimum value (step ST37). After that, the navigation processing unit advances the sequence to step ST38.

In step ST38, whether or not the maximum Y coordinate Y3 is larger than the Y coordinate maximum value is checked to see. When, in this step ST38, determining that the maximum Y coordinate Y3 is not larger than the Y coordinate maximum value, the navigation processing unit advances the sequence to step ST40. In contrast, when, in step ST38, determining that the maximum Y coordinate Y3 is larger than the Y coordinate maximum value, the navigation processing unit redefines the maximum Y coordinate Y3 as the Y coordinate maximum value (step ST39). After that, the navigation processing unit advances the sequence to step ST40.

In step ST40, whether or not the minimum Y coordinate Y4 is smaller than the Y coordinate maximum value is checked to see. When, in this step ST40, determining that the minimum Y coordinate Y4 is not smaller than the Y coordinate maximum value, the navigation processing unit advances the sequence to step ST42. In contrast, when, in step ST40, determining that the minimum Y coordinate Y4 is smaller than the Y coordinate maximum value, the navigation processing unit redefines the minimum Y coordinate Y4 as the Y coordinate maximum value (step ST41). After that, the navigation processing unit advances the sequence to step ST42.

In step ST42, the link connected to the end node of the link R2 in the traveling direction is defined as a new link R2. Whether or not the tunnel flag of the link R2 is “1” is then checked to see (step ST43). When, in this step ST42, determining that the tunnel flag of the link R2 is not “1”, the navigation processing unit recognizes that the end node of the link R2 is a tunnel end point, ends the tunnel shape determination processing, and then returns the sequence to the main processing. In contrast, when, in step ST42, determining that the tunnel flag of the link R2 is “1”, the navigation processing unit returns the sequence to step ST33 and repeats the above-mentioned processes.

When the above-mentioned tunnel shape determination processing is completed, map image scale determination processing is then carried out (step ST13). The details of this map image scale determination processing will be explained with reference to the flow chart shown in FIG. 5.

In the map image scale determination processing, the coordinate difference between the X coordinate minimum value and the X coordinate maximum value is calculated first (step ST51). More specifically, the navigation processing unit 25 calculates the coordinate difference in the X direction by determining the difference between the X coordinate minimum value and the X coordinate maximum value which are calculated through the above-mentioned tunnel shape determination processing.

A display scale C1 corresponding to the coordinate difference in the X direction is then determined (step ST52). More specifically, the navigation processing unit 25 refers to the display scale table as shown in FIG. 6 read from the HDD 23 via the control unit 27 to determine the display scale C1 corresponding to the coordinate difference in the X direction calculated in step ST51. For example, when the coordinate difference in the X direction calculated in step ST51 is less than 10 seconds, the navigation processing unit determines the display scales as a scale of 1 cm to 50 m, and, when the coordinate difference in the X direction is equal to or more than 10 seconds and is less than 20 seconds, the navigation processing unit determines the display scales as a scale of 1 cm to 100 m.

The coordinate difference between the Y coordinate maximum value and the Y coordinate maximum value is then calculated (step ST53). More specifically, the navigation processing unit 25 calculates the coordinate difference in the Y direction by determining the difference between the Y coordinate maximum value and the Y coordinate maximum value which are calculated through the above-mentioned tunnel shape determination processing.

A display scale C2 corresponding to the coordinate difference in the Y direction is then determined (step ST54). More specifically, the navigation processing unit 25 refers to the display scale table to determine the display scale C2 corresponding to the coordinate difference in the Y direction calculated in step ST53. For example, when the coordinate difference in the Y direction calculated in step ST53 is less than 15 seconds, the navigation processing unit determines the display scale as a scale of 1 cm to 50 m, and, when the coordinate difference in the Y direction is equal to or more than 15 seconds and is less than 30 seconds, the navigation processing unit determines the display scale as a scale of 1 cm to 100 m.

Whether or not the scale C2 is intended for a larger regional map than that for which the scale C1 is intended is then checked to see (step ST55). More specifically, the navigation processing unit 25 checks to see whether the use of the scale C2 determined in step ST54 can display a larger regional map than that displayed by using the scale C1 determined in step ST52.

When it is determined, in this step ST55, that the scale C2 is intended for a larger regional map than that for which the scale C1 is intended, the scale C2 is set finally as the display scale (step ST56). More specifically, the navigation processing unit 25 creates a map image about a map having the scale C2 in which the whole shape of the tunnel is to be displayed on a single screen by using the map display function, and sends the map image to the output control unit 26 via the control unit 27. The output control unit 26 generates an image signal according to the map image sent thereto, via the control unit 27, from the navigation processing unit 25, and sends the image signal to the display unit 15. As a result, the map having the display scale C2 including the whole shape of the tunnel is displayed on the screen of the display unit 15. After that, the navigation processing unit returns to the main processing.

In contrast, when it is determined, in step ST55, that the scale C2 is not intended for a larger regional map than that for which the scale C1 is intended, the scale C1 is set finally as the display scale (step ST57). More specifically, the navigation processing unit 25 creates a map image about a map having the scale C1 in which the whole shape of the tunnel is to be displayed on a single screen by using the map display function, and sends the map image to the output control unit 26 via the control unit 27. The output control unit 26 generates an image signal according to the map image sent thereto, via the control unit 27, from the navigation processing unit 25, and sends the image signal to the display unit 15. As a result, the map having the display scale C1 including the whole shape of the tunnel is displayed on the screen of the display unit 15. After that, the navigation processing unit returns to the main processing and then ends the main processing.

Because when the vehicle has entered a tunnel, the map information processing device in accordance with Embodiment 1 of the present invention displays a map whose display scale has been changed in such a way that the map contains the whole shape of the tunnel, the psychological burden on the driver resulting from being unable to know any information about tunnel exits can be reduced.

Although the display scale table shown in FIG. 6 is stored in the HDD 23, the display scale table can be alternatively incorporated into a program for implementing the tunnel display processing performed by the navigation processing unit 25. Furthermore, the numerical values shown in the display scale table are examples, and can be determined arbitrarily.

### Embodiment 2

The map information processing device in accordance with Embodiment 2 of the present invention has the same structure as that in accordance with Embodiment 1 shown in FIG. 1.

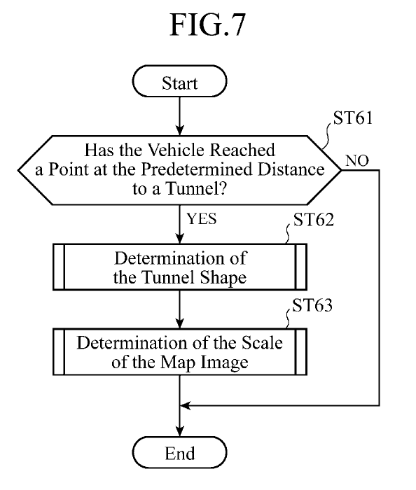

Next, the operation of the map information processing device in accordance with Embodiment 2 will be explained. FIG. 7 is a flow chart showing main processing in tunnel display processing.

In the main processing, whether a vehicle equipped with the map information processing device has reached a point at a predetermined distance to a tunnel is checked to see first (step ST61). More specifically, a navigation processing unit 25 checks to see whether or not there exists a road whose tunnel flag varies from “0” to “1” at the predetermined distance or less from the current position in the traveling direction. More specifically, the navigation processing unit 25 calculates the current position by using a current position calculation function to determine if the tunnel flag added to a link corresponding to the road where this calculated current position exists is “0” and the tunnel flag added to a link corresponding to a road section existing forward at the predetermined distance from the current position in the traveling direction is “1”. More specifically, the navigation processing unit checks to see whether the tunnel flag varies from “0” to “1” at a point positioned forward at the predetermined distance from the current position in the traveling direction. When, in this step ST61, determining that the vehicle has not reached a point at the predetermined distance to any tunnel, the navigation processing unit recognizes that the vehicle will not enter any tunnel when traveling along the road section corresponding to the next link, and then ends the main processing.

In contrast, when, in step ST61, determining that the vehicle has reached a point at the predetermined distance to a tunnel, the navigation processing unit recognizes that the vehicle will enter the tunnel when traveling along the road section corresponding to the next link, and then carries out tunnel shape determination processing (step ST62). The processing in this step ST62 is the same as that in step ST12 in the main processing carried out by the map information processing device in accordance with above-mentioned Embodiment 1. Map image scale determination processing is then carried out (step ST63). The processing in this step ST63 is the same as that in step ST13 of the main processing carried out by the map information processing device in accordance with above-mentioned Embodiment 1, with the exception that the display scale is determined in such a way that the point at the predetermined distance to the tunnel is taken into consideration. After that, the navigation processing unit ends the main process display processing.

As explained above, because when the vehicle has reached a point before entering a tunnel, the map information processing device in accordance with Embodiment 2 of the present invention displays a map whose display scale has been changed in such a way that the whole of a route extending from the point to the end point of the tunnel and including the whole shape of the tunnel is contained in the map, the psychological burden on the driver resulting from being unable to know any information about tunnel exits can be reduced.

The “predetermined distance” used in above-mentioned step ST61 can be changed according to the type of the road, e.g., whether or not the road along which the vehicle is traveling is a highway.

### INDUSTRIAL APPLICABILITY

Because when the vehicle has entered a tunnel, the map information processing device in accordance with the present invention displays a map image including the whole shape of the tunnel in such a way that the map image is included in a single screen, the psychological burden on the driver resulting from being unable to acquire any information about tunnel exits can be reduced. Therefore, the map information processing device in accordance with the present invention is suitable for use as a map information processing device for processing map information in a navigation device, particularly as a map information processing device which ideally displays map information when the vehicle is traveling through a tunnel, or the like.

1. A map information processing device comprising:
a map information storage unit for storing map information;
a sensor information input unit for inputting sensor information used for calculation of a current position;
a navigation processing unit for, when determining that a vehicle has entered a tunnel on a basis of a current position which said navigation processing unit calculates by using the map information read from said map information storage unit and the sensor information inputted from said sensor information input unit, creating a map image having a display scale with which a whole shape of said tunnel is included in a single screen; and
an output control unit for outputting the map image created by said navigation processing unit.

2. A map information processing device comprising:
a map information storage unit for storing map information;
a sensor information input unit for inputting sensor information used for calculation of a current position;
a navigation processing unit for, when determining that a vehicle has reached a point at a predetermined distance to a tunnel on a basis of a current position which said navigation processing unit calculates by using the map information read from said map information storage unit and the sensor information inputted from said sensor information input unit, creating a map image having a display scale with which a route extending from said point to an end point of said tunnel and including a whole shape of said tunnel is included in a single screen; and
an output control unit for outputting the map image created by said navigation processing unit.
